(19) United States
(12) Patent Application Publication
(10) Pub. No.: US 2017/0116218 A1
(43) Pub. Date: Apr. 27, 2017

(54) METHOD FOR SYNCHRONIZING DATA DEDUPLICATION DICTIONARY

(71) Applicant: SAMSUNG SDS CO., LTD., Seoul (KR)

(72) Inventors: Ki-Woon SUNG, Seoul (KR); Kyu-Sang LEE, Seoul (KR); Jae-Seok LEE, Seoul (KR)

(73) Assignee: SAMSUNG SDS CO., LTD., Seoul (KR)

(21) Appl. No.: 15/060,848

(22) Filed: Mar. 4, 2016

(30) Foreign Application Priority Data
Oct. 22, 2015 (KR) 10-2015-0147080

(51) Int. Cl. G06F 17/30; G06F 17/27; H04L 29/08

(52) U.S. Cl. CPC G06F 17/30159; H04L 67/06; G06F 17/2735; G06F 17/30117

(57) ABSTRACT

Disclosed is a dictionary synchronization method for synchronizing dictionaries between a transmitting server and a receiving server. The dictionary synchronization method comprising registering entry information on a new chunk file and a flag value indicating whether the entry information is valid in the dictionary of the transmitting server, storing the entry information on the new chunk file in a temporary dictionary of the transmitting server, transmitting the entry information on the new chunk file to the receiving server and deleting the entry information on the new chunk file stored in the temporary dictionary upon receipt of a confirmation signal indicating that the entry information on the new chunk file has been registered in the dictionary of the receiving server.

### CROSS-REFERENCE TO RELATED APPLICATION

This application claims priority from Korean Patent Application No. 10-2015-0147080 filed on Oct. 22, 2015 in the Korean Intellectual Property Office, the disclosure of which is incorporated herein by reference in its entirety.

### BACKGROUND

1. Technical Field

The present inventive concept relates to a method for synchronizing a data deduplication dictionary, and more particularly, to a method for synchronizing a data deduplication dictionary in which a transmitting side dictionary is updated after receiving an entry information registration signal from a receiving proxy server, thereby achieving in-advance prevention against discordance of dictionary information.

2. Description of the Related Art

Data deduplication refers to a technique for detecting and eliminating duplication between different data in order to improve efficiency of storage utilization and reduce traffic load generated during data transmission.

Dictionary information synchronization is a prerequisite for recovering original data using chunk file in a paired-proxy structure in which two proxy servers are paired each.

FIG. 1 and FIG. 2 illustrate a data transmitting/receiving method through data deduplication and problems which may occur when dictionary information synchronization is not performed.

Referring to FIG. 1, a first proxy server 10 may have a first chunk file 11 to a fifth chunk file 15 and entry information on each chunk file, for example, a hash value of each chunk file pre-stored therein.

Similarly, a second proxy server 20 may have a first chunk file 11 to a third chunk file 13, a sixth chunk file 16 and a hash value of each chunk file pre-stored therein.

In this case, when the first proxy server 10 transmits first data 30 to the second proxy server 20, the first proxy server 10 may not transmit data itself but transmit a hash value corresponding to the first data 30 to the second proxy server 20.

The second proxy server 20 which has received the hash value corresponding to the first data 30 searches a chunk file corresponding to the hash value so as to recover original data. That is, data itself is not transmitted but only the hash value of which capacity is smaller than that of data is transmitted, thereby reducing traffic load during transmission.

However, in the data transmission method described above, original data cannot be recovered when synchronization of dictionary information stored in the first proxy server 10 and the second proxy server 20, that is, a chunk file and information on the chunk file, is not achieved.

For example, when the first proxy server 10 transmits second data 40 to the second proxy server 20, if dictionary information on the fifth chunk file 15 is not synchronized, the second proxy server 20 which has received data in the format of hash values of the first chunk file 11 and the fifth chunk file 15 may not recover the second data 40 which is original data.

Discordance of dictionary information may occur as shown in FIG. 2.

When a first new chunk file is created, the first proxy server 10 registers entry information on the first new chunk file in a dictionary thereof (S21). In this case, the entry information may be a hash value of the newly created first new chunk file.

The first proxy server 10 which has registered the entry information on the first new chunk file in the dictionary transmits the entry information on the first new chunk file to the second proxy server 20 (S22). The second proxy server 20 which has received information on the first new chunk file stores the received information in a dictionary thereof (S23).

Subsequently, when a second new chunk file is created, the first proxy server 10 stores entry information on the second new chunk file in the dictionary (S24) and transmits the entry information on the second new chunk file to the second proxy server 20 (S25).

In this case, when a communication between the first proxy server 10 and the second proxy server 20 has been terminated abnormally, the entry information on the second new chunk file is registered only in the dictionary of the first proxy server 10 but not registered in the second proxy server 20 (S26).

Thus, since the second proxy server 20 which has received the hash value of the second new chunk file does not have the hash value of the second new chunk file stored therein, the proxy server 20 may not recover original data including the second new chunk file.

A need therefore exists for a novel method for synchronizing dictionary information capable of preemptively preventing a discordance of dictionary information between a transmitting proxy server and a receiving proxy server.

Prior Art Document: U.S. Pat. No. 8,937,561

### SUMMARY

Aspects of the present inventive concept provide a dictionary synchronization method capable of preemptively preventing a discordance of dictionary information between a transmitting server and a receiving server.

However, embodiments of the present inventive concept are not restricted to the one set forth herein. The other embodiments of the present inventive concept which are not mentioned herein will become more apparent to one of ordinary skilled in the art to which the present inventive concept pertains by referencing the detailed description of the present inventive concept given below.

According to embodiments of the present inventive concept, a dictionary synchronization method is provided in which a dictionary is managed on the basis of a received confirmation signal indicating a normal registration of entry information, thereby preemptively preventing an error in data transmission caused by a discordance of dictionary information between a transmitting server and a receiving server.

In an embodiment of the present invention, wherein registering a flag value indicating whether the entry information is valid in the dictionary of the transmitting server includes registering the flag value in the dictionary of the transmitting server such that the flag value has a value indicating that the entry information is valid.

In an embodiment of the present invention, the method further comprising maintaining the entry information on the new chunk file in the temporary dictionary, and changing the flag value such that the flag value has a value indicating that the entry information is invalid.

In an embodiment of the present invention, the method further comprising re-transmitting the entry information on the new chunk file stored in the temporary dictionary to the receiving server.

According to another aspect of the present invention, there is provided a dictionary synchronization method for synchronizing dictionaries between a transmitting server and a receiving server, the dictionary synchronization method comprising: registering entry information on a new chunk file and a flag value indicating whether the entry information is valid in the dictionary of the transmitting server, transmitting the entry information on the new chunk file to the receiving server and changing the flag value upon receipt of a confirmation signal indicating that the entry information on the new chunk file has been registered in the dictionary of the receiving server.

In an embodiment of the present invention wherein registering a flag value in the dictionary of the transmitting server includes registering the flag value in the dictionary of the transmitting server such that the flag value has a value indicating that the entry information is invalid.

In an embodiment of the present invention wherein changing the flag value includes changing the flag value such that the flag value has a value indicating that the entry information is valid.

In an embodiment of the present invention wherein registering entry information on a new chunk file and a flag value indicating whether the entry information is valid in the dictionary of the transmitting server includes registering a lot number which is an identifier allocated to a group including a plurality of new chunk files in the dictionary of the transmitting server.

In an embodiment of the present invention wherein changing the flag value includes, upon receipt of a confirmation signal indicating that a plurality of new chunk files having the same lot number allocated thereto have been registered in the dictionary of the receiving server, changing flag values of the new chunk files corresponding to the lot number.

According to another aspect of the present invention, there is a dictionary synchronization method for synchronizing dictionaries between a transmitting server and a receiving server, the dictionary synchronization method comprising: registering entry information on a new chunk file and a flag value indicating whether the entry information is valid in the dictionary of the transmitting server, transmitting the entry information on the new chunk file to the receiving server, receiving a confirmation signal indicating that the entry information on the new chunk file has been registered in the dictionary of the receiving server and changing the flag value of the new chunk file for which the confirmation signal has been received upon termination of a communication session with the receiving server.

In an embodiment of the present invention, wherein registering a flag value in the dictionary of the transmitting server includes registering the flag value in the dictionary of the transmitting server such that the flag value has a value indicating that the entry information is invalid.

In an embodiment of the present invention, wherein changing the flag value includes changing the flag value such that the flag value has a value indicating that the entry information is valid.

In an embodiment of the present invention, wherein registering entry information on a new chunk file and a flag value indicating whether the entry information is valid in the dictionary of the transmitting server includes registering a lot number which is an identifier allocated to a group including a plurality of new chunk files in the dictionary of the transmitting server.

In an embodiment of the present invention, wherein changing the flag value includes, upon receipt of a confirmation signal indicating that a plurality of new chunk files having the same lot number allocated thereto have been registered in the dictionary of the receiving server, changing flag values of the new chunk files corresponding to the lot number.

According to another aspect of the present invention, there is provided a dictionary synchronization method for synchronizing dictionaries between a transmitting server and a receiving server, the dictionary synchronization method comprising: storing entry information on a new chunk file and a flag value indicating whether the entry information is valid in a temporary dictionary of the transmitting server, transmitting the entry information on the new chunk file to the receiving server, changing the flag value stored in the temporary dictionary upon receipt of a confirmation signal indicating that the entry information on the new chunk file has been registered in the dictionary of the receiving server and registering the entry information on the new chunk file of which flag value has been changed in the dictionary of the transmitting server upon termination of a communication session with the receiving server.

In an embodiment of the present invention, the wherein storing entry information on a new chunk file and a flag value indicating whether the entry information is valid in a temporary dictionary of the transmitting server includes storing the flag value in the temporary dictionary of the transmitting server such that the flag value has a value indicating that the entry information is invalid.

In an embodiment of the present invention, the wherein changing the flag value stored in the temporary dictionary includes changing the flag value such that the flag value has a value indicating that the entry information is valid.

According to another aspect of the present invention, there is provided a server comprising: one or more processors, a memory in which a computer program executed by the processors is loaded and a storage in which a computer program for dictionary synchronization is stored, wherein the computer program includes: an operation for registering entry information on a new chunk file and a flag value indicating whether the entry information is valid in a dictionary of a transmitting server; an operation for storing the entry information on the new chunk file in a temporary dictionary of the transmitting server, an operation for transmitting the entry information on the new chunk file to a receiving server and an operation for deleting the entry information on the new chunk file stored in the temporary dictionary upon receipt of a confirmation signal indicating that the entry information on the new chunk file has been registered in a dictionary of the receiving server.

According to another aspect of the present invention, there is provided a server comprising: one or more processors, a memory in which a computer program executed by the processors is loaded and a storage in which a computer program for dictionary synchronization is stored, wherein the computer program includes: an operation for registering entry information on a new chunk file and a flag value indicating whether the entry information is valid in a dictionary of a transmitting server, an operation for transmitting the entry information on the new chunk file to a receiving server and an operation for changing the flag value upon receipt of a confirmation signal indicating that the entry information on the new chunk file has been registered in a dictionary of the receiving server.

According to another aspect of the present invention, there is provided a server one or more processors, a memory in which a computer program executed by the processors is loaded and a storage in which a computer program for dictionary synchronization is stored, wherein the computer program includes: an operation for registering entry information on a new chunk file and a flag value indicating whether the entry information is valid in a dictionary of a transmitting server, an operation for transmitting the entry information on the new chunk file to a receiving server, an operation for receiving a confirmation signal indicating that the entry information on the new chunk file has been registered in a dictionary of the receiving server and an operation for changing the flag value of the new chunk file for which the confirmation signal has been received upon termination of a communication session with the receiving server.

According to another aspect of the present invention, there is provided a server comprising: one or more processors, a memory in which a computer program executed by the processors is loaded and a storage in which a computer program for dictionary synchronization is stored, wherein the computer program includes: an operation for storing entry information on a new chunk file and a flag value indicating whether the entry information is valid in a temporary dictionary of a transmitting server, an operation for transmitting the entry information on the new chunk file to a receiving server, an operation for changing the flag value stored in the temporary dictionary upon receipt of a confirmation signal indicating that the entry information on the new chunk file has been registered in a dictionary of the receiving server and an operation for registering the entry information on the new chunk file of which flag value has been changed in a dictionary of the transmitting server upon termination of a communication session with the receiving server.

### BRIEF DESCRIPTION OF THE DRAWINGS

FIG. 1 and FIG. 2 illustrate a data transmitting/receiving method through data deduplication and problems which may occur when dictionary information synchronization is not performed;

FIG. 3 is a flowchart illustrating a dictionary synchronization method according to a first embodiment;

FIG. 4 is a flowchart illustrating when a confirmation signal is not received in the dictionary synchronization method according to the first embodiment;

FIG. 5 is a flowchart illustrating a dictionary synchronization method according to a second embodiment;

FIG. 6 is a flowchart illustrating a dictionary synchronization method on the basis of a received confirmation signal for a plurality of chunk files according to the second embodiment;

FIG. 7 is a flowchart illustrating a dictionary synchronization method according to a third embodiment;

FIG. 8 is a flowchart illustrating a dictionary synchronization method on the basis of a received confirmation signal for a plurality of chunk files according to the third embodiment;

FIG. 9 is a flowchart illustrating a dictionary synchronization method according to a fourth embodiment; and

FIG. 10 is a functional block diagram illustrating a server 1000 according to one embodiment of the present inventive concept.

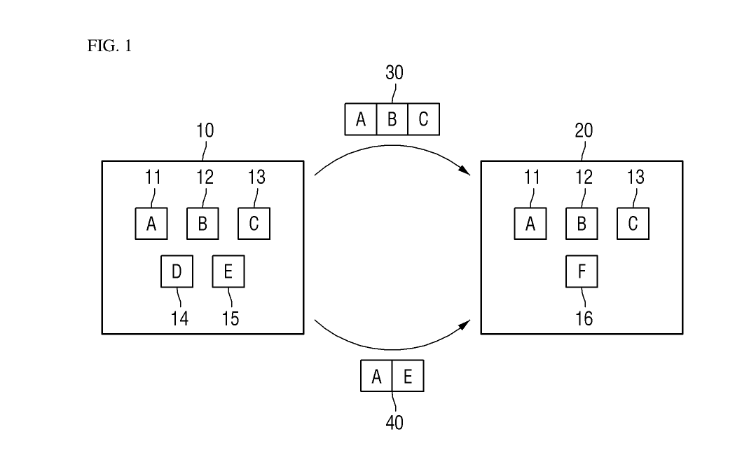

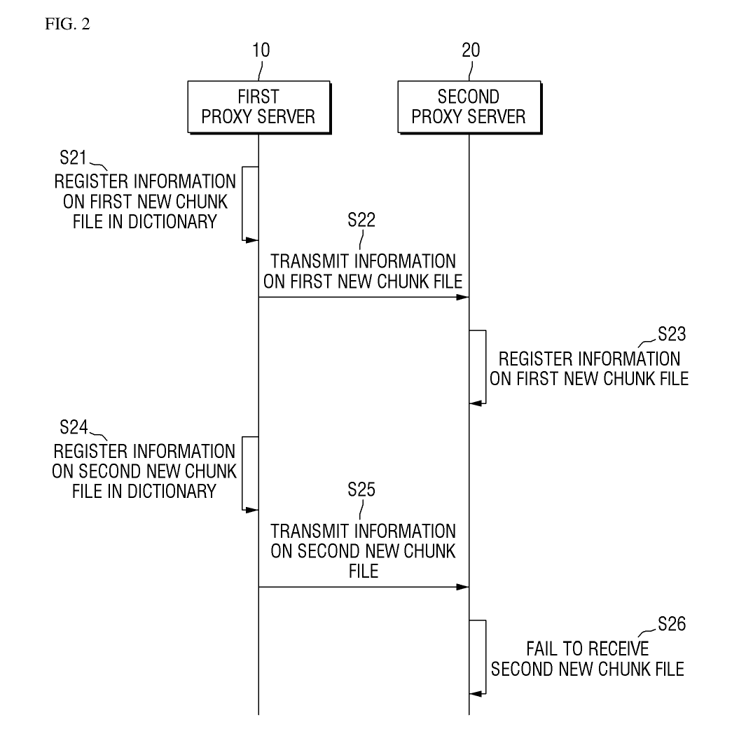

### DETAILED DESCRIPTION OF THE EMBODIMENTS

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like numbers refer to like elements throughout.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In addition, it will be understood that the singular forms are intended to include the plural forms as well. It will be further understood that the terms “comprises” and/or “comprising,” when used in this specification, specify the presence of stated features, integers, steps, operations, elements, and/or components, but do not preclude the presence or addition of one or more other features, operations, elements, and/or components thereof.

The terms used herein will now be defined as below to clearly describe the inventive concept.

Entry Information

The term “entry information” refers to information for identifying a chunk file created for data deduplication. For example, entry information may include a chunk file and a hash value of the chunk file.

Thus, even when only a hash value of a certain chunk file is received, the chunk file corresponding to the hash value may be identified by using the entry information.

Dictionary

The term “dictionary” refers to a collection of entry information. To transmit/receive data through data deduplication, entry information on a plurality of chunk files should have been pre-stored in transmitting/receiving servers, and a collection of entry information on the plurality of chunk files is a dictionary.

When a new chunk file is created, data transmission/reception may be enabled when the dictionary is updated with entry information on the new chunk file and the updated dictionary is synchronized between a transmitting server and a receiving server.

### First Embodiment

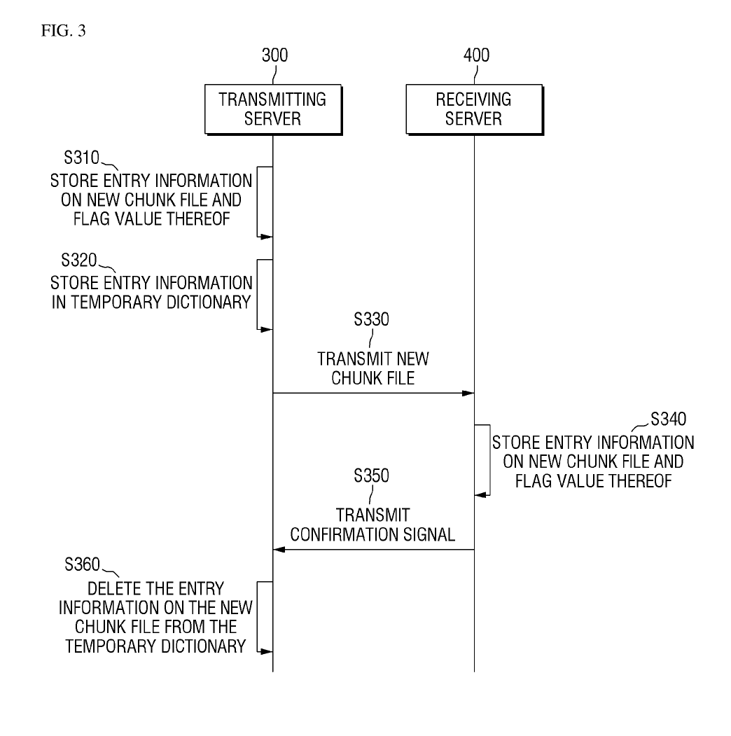

FIG. 3 is a flowchart illustrating a dictionary synchronization method according to a first embodiment.

Hereinafter, a transmitting server 300 and a receiving server 400 may be a proxy server, but the present disclosure is not limited thereto, and the transmitting server 300 and the receiving server 400 may be a general server capable of transmitting/receiving data through data deduplication.

When a new chunk file is created, the transmitting server 300 may register entry information on the new chunk file and a flag value thereof in a dictionary (S310). The flag value indicates whether the corresponding entry information is valid, and if the corresponding entry information is valid, the flag value may be stored as “flag=true” and if the corresponding entry information is not valid, the flag value may be stored as “flag=false”.

That is, the entry information which is “flag=false” means that the entry information is not registered in the receiving server 400, and thus the chunk file corresponding to that entry information may be determined as those which cannot be used in data deduplication. An initial flag value may be registered as being “flag=true” in the dictionary.

Subsequently, the transmitting server 300 may store entry information on the new chunk file in a temporary dictionary (S320). In this case, the temporary dictionary may be stored in a temporary recording medium such as a buffer or a memory.

When the above-described process is completed, the transmitting server 300 may transmit the new chunk file to the receiving server 400 (S330). Similarly to the transmitting server 300, the receiving server 400 which has received the new chunk file may register entry information on the new chunk file and a flag value thereof in a dictionary (S340).

Subsequently, the receiving server 400 may transmit a confirmation signal indicating that the entry information on the new chunk file has been normally registered in the dictionary to the transmitting server 300 (S350).

The transmitting server 300 which has received the confirmation signal may determine that the entry information on the new chunk file has been normally registered in the receiving server 400, and delete the entry information on the new chunk file from the temporary dictionary (S360).

Since the flag value of the new chunk file normally registered in the receiving server 400 is maintained as “flag=true” value which means that the corresponding entry information on the new chunk file has been normally registered in the receiving server 400, the transmitting server 300 may transmit later a hash value corresponding to the new chunk file when transmitting data including the new chunk file so as to enable the receiving server 400 to recover the new chunk file.

Meanwhile, the communication with the receiving server 400 may terminate without receiving, from the receiving server 400, a confirmation signal indicating a normal registration of the entry information on the new chunk file.

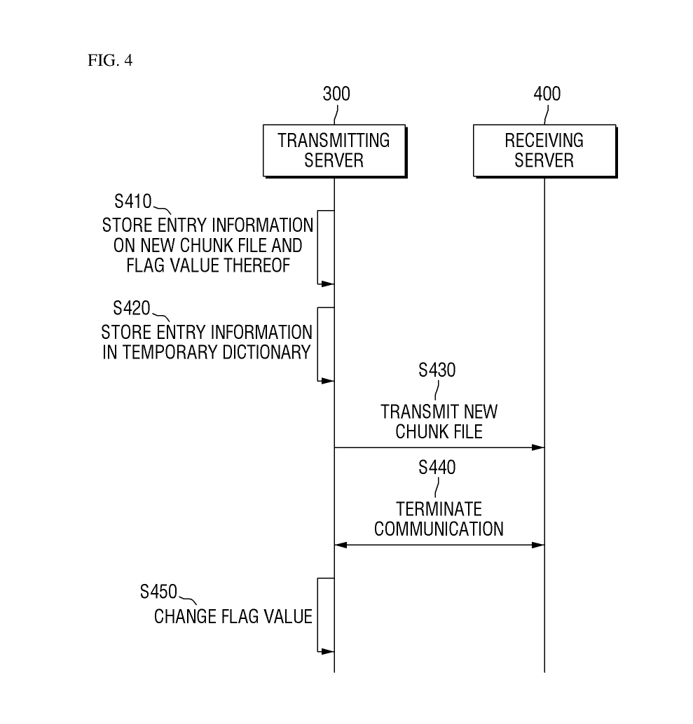

FIG. 4 is a flowchart illustrating when a confirmation signal is not received in the dictionary synchronization method according to the first embodiment.

When a new chunk file is created, entry information and flag value thereof may be registered in a dictionary (S410), the entry information may be stored in a temporary dictionary (S420), and the new chunk file may be transmitted to the receiving server 400 (S430) like those described with reference to FIG. 3, and thus duplicated descriptions will be omitted.

Although the transmitting server 300 has transmitted the new chunk file, the communication may terminate without receiving, from the receiving server 400, a confirmation signal indicating a normal registration of the entry information on the new chunk file (S440).

In this case, the transmitting server 300 may change the flag value of the new chunk file registered in the dictionary (S450). Specifically, the transmitting server 300 may change the flag value of the chunk file for which a confirmation signal has not been received, to “flag=false”.

Thus, the transmitting server 300 may confirm that the entry information on the chunk file of which flag value is false has not been registered in the receiving server 400, and therefore, the transmitting server 300 may transmit the corresponding chunk file itself rather than a hash value to the receiving server 400.

Furthermore, since entry information on a chunk file which has not been normally registered in the receiving server 400 is stored in the temporary dictionary, the entry information stored in the temporary dictionary can be transmitted again to the receiving server 400 later so as to achieve dictionary synchronization.

As discussed above, the dictionary is managed on the basis of the confirmation signal received from the receiving server 400 indicating a normal registration of the entry information on the new chunk file, thereby preemptively preventing an error in data transmission caused by a discordance of dictionary information between the transmitting server and the receiving server.

### Second Embodiment

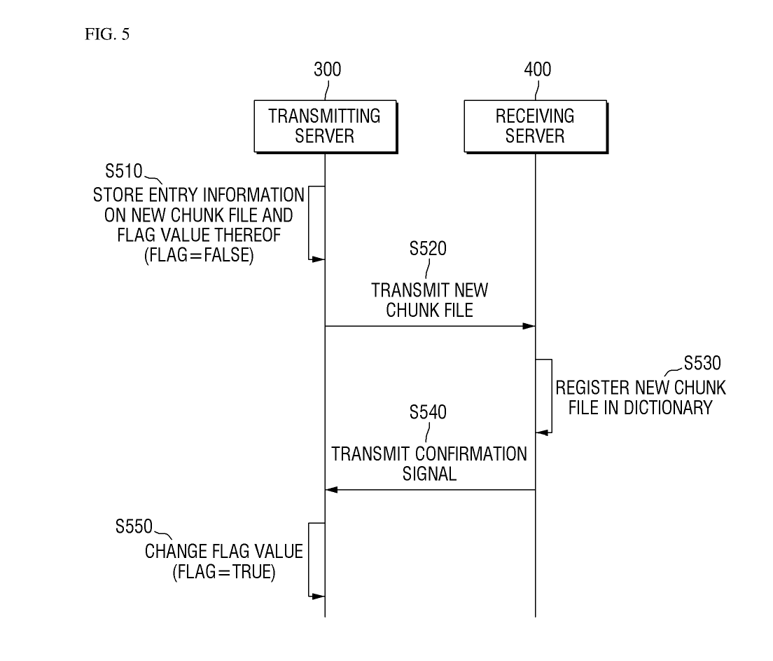

FIG. 5 is a flowchart illustrating a dictionary synchronization method according to a second embodiment.

When a new chunk file is created, the transmitting server 300 may register the entry information on the new chunk file and a flag value thereof in a dictionary (S510). In this case, an initial flag value is stored as “flag=false” which means that the entry information is not valid.

Subsequently, the transmitting server 300 may transmit the new chunk file to the receiving server 400 (S520). The receiving server 400 which has received the new chunk file may register the new chunk file and the entry information on the new chunk file in a dictionary (S530).

The receiving server 400 may transmit, to the transmitting server 300, a confirmation signal indicating that the new chunk file and the entry information on the new chunk file have been normally registered in the dictionary (S540).

The transmitting server 300 may change the flag value of the new chunk file upon receipt of the confirmation signal. Specifically, the transmitting server 300 may change the flag value to “flag=true” which means that the entry information on the new chunk file is a valid value (S550).

That is, the transmitting server 300 may change the flag value of the new chunk file upon receipt of the confirmation signal from the receiving server 400 regardless of whether a communication session between the transmitting server 300 and the receiving server 400 has been terminated or not.

Although in the foregoing description of exemplary embodiments, confirmation signals are received from the receiving server 400 for each chunk file, but the same lot number may be assigned to a plurality of new chunk files and confirmation signals for the lot number may be received so as to change the flag values of new chunk files corresponding to the lot number.

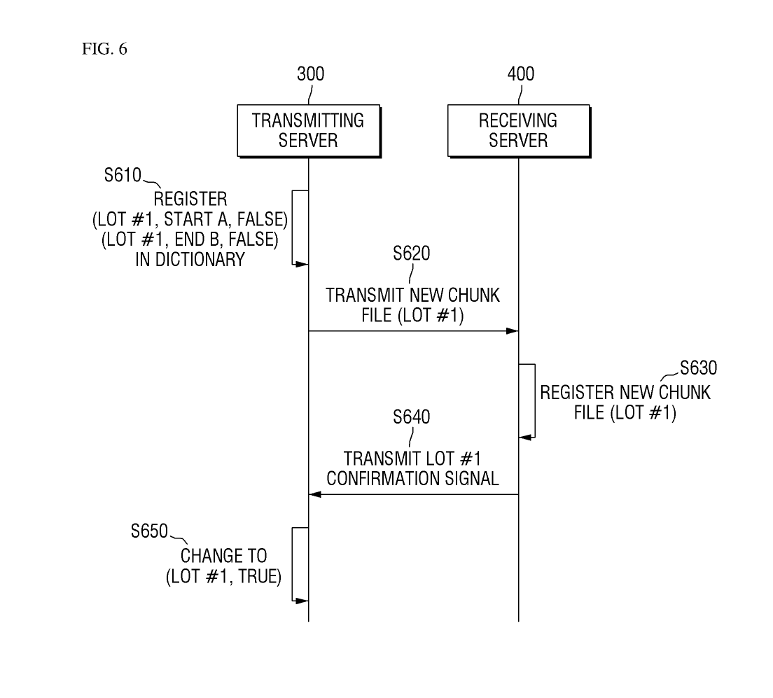

FIG. 6 is a flowchart illustrating a dictionary synchronization method on the basis of a received confirmation signal for a plurality of chunk files according to the second embodiment.

The lot number may be an identifier allocated to the group including the plurality of new chunk files. For example, when new chunk files A and B are created, the created new chunk files A and B may be designated as a single group and an identifier “LOT #1” may be assigned to the group.

In the second embodiment, entry information on the new chunk file, a flag value and a lot number allocated to the new chunk file may be registered together in a dictionary (S610). In this case, an initial flag value may be registered as “flag=false”.

Subsequently, the transmitting server 300 may transmit the plurality of new chunk files having the same lot number allocated thereto to the receiving server 400 (S620). The receiving server 400 which has received the plurality of new chunk files having the same lot number allocated thereto may register the received plurality of new chunk files and entry information on the new chunk files in a dictionary (S630), and transmit, to the transmitting server 300, a confirmation signal indicating that the new chunk files having the lot number allocated thereto have been normally registered in the dictionary of the receiving server 400 (S640).

That is, the confirmation signal may include the lot number, and the transmitting server 300 which has received the confirmation signal may determine that the chunk files corresponding to the lot number included in the confirmation signal have been normally registered in the receiving server 400.

The transmitting server 300 which has received the confirmation signal may change flag value of chunk files corresponding to the lot number (S650). Specifically, the flag value which is initially set as “flag=false” may be changed to “flag=true”.

As discussed above, when the confirmation signal including the lot number is received, the flag value of the plurality of chunk files can be changed just through a single receipt of the confirmation signal, thereby reducing unnecessary traffic load when compared with receiving a confirmation signal whenever a chunk file is normally registered in the receiving server 400.

### Third Embodiment

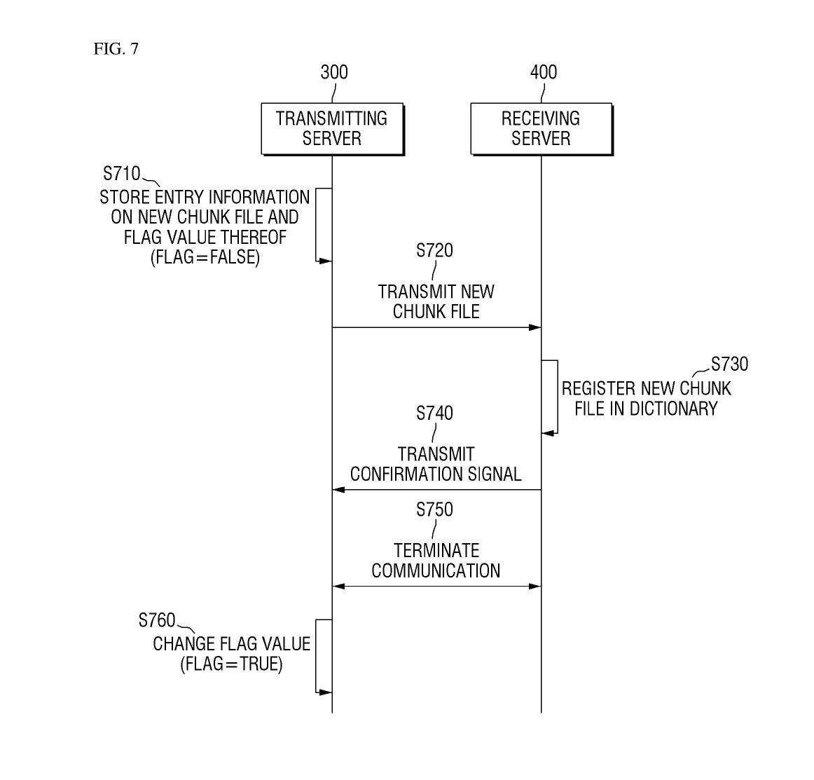

FIG. 7 is a flowchart illustrating a dictionary synchronization method according to a third embodiment.

When a new chunk file is created, the transmitting server 300 may register entry information on the new chunk file and a flag value thereof in a dictionary (S710). In this case, an initial flag value may be stored as “flag=false” which means that the entry information is not valid.

Subsequently, the transmitting server 300 may transmit the new chunk file to the receiving server 400 (S720). The receiving server 400 which has received the new chunk file may register the new chunk file and entry information on the new chunk file in a dictionary (S730).

The receiving server 400 may transmit, to the transmitting server 300, a confirmation signal indicating that the new chunk file and the entry information on the new chunk file have been normally registered in the dictionary (S740).

The transmitting server 300 may temporarily store therein a list of the new chunk files for which confirmation signals have been received, and when a communication session with the receiving server 400 has been terminated (S750), the transmitting server 300 may change the flag values of the new chunk files for which confirmation signals have been received (S760).

That is, since changing the flag value of the new chunk file upon every receipt of a confirmation signal may cause unnecessary load, the flag values of the new chunk files for which confirmation signals have been received are changed in a batch after termination of the communication session.

Meanwhile, a confirmation signal for the lot number may be received and flag values of the new chunk files belonging to the group to which the lot number is allocated may be changed in a batch.

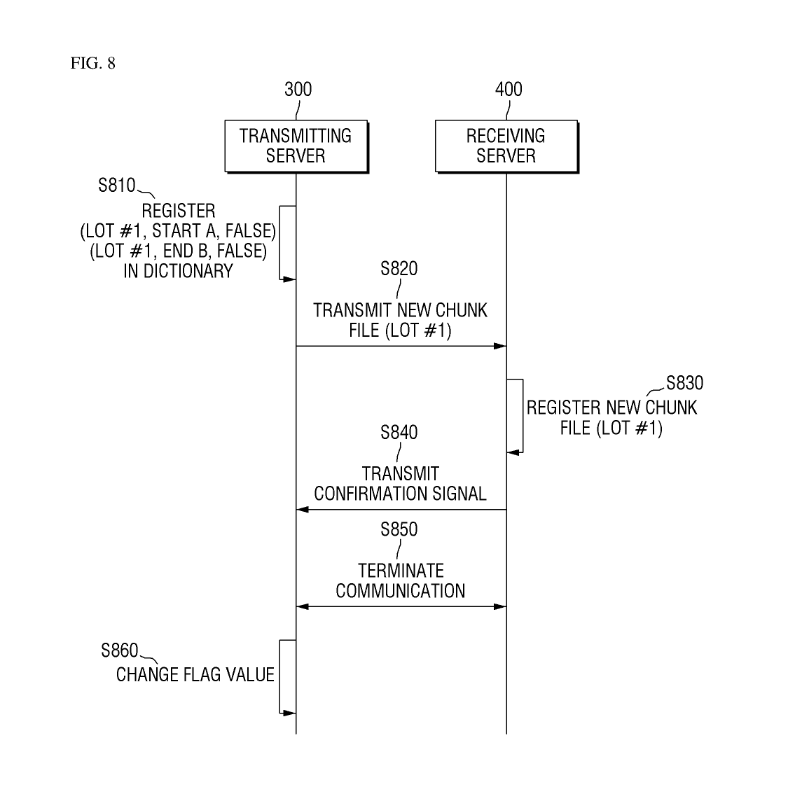

FIG. 8 is a flowchart illustrating a dictionary synchronization method on the basis of a received confirmation signal for a plurality of chunk files according to the third embodiment.

Lot numbers have been described above with reference to FIG. 6, and thus duplicated descriptions thereof will be omitted.

The transmitting server 300 may register entry information on the new chunk file, a flag value thereof and a lot number allocated to the new chunk file in a dictionary (S810). In this case, an initial flag value may be registered as “flag=false”.

Subsequently, the transmitting server 300 may transmit the plurality of new chunk files having the same lot number allocated thereto to the receiving server 400 (S820). The receiving server 400 which has received the plurality of new chunk files having the same lot number allocated thereto// may register the received plurality of new chunk files and entry information on the new chunk files in a dictionary (S830), and transmit, to the transmitting server 300, a confirmation signal indicating that the new chunk files having the lot number allocated thereto have been normally registered in the dictionary of the receiving server 400 (S840).

The transmitting server 300 may temporarily store therein a list of the lot numbers for which confirmation signals have been received, and when a communication session with the receiving server 400 has been terminated (S850), the transmitting server 300 may change the flag values of the new chunk files having lot numbers allocated thereto for which confirmation signals have been received (S860).

For example, when the confirmation signal for “LOT #1” has been received, and the communication session with the receiving server 400 has been terminated, flag values of chunk files A and B to which “LOT #1” is allocated may be changed to “flag=true”.

### Fourth Embodiment

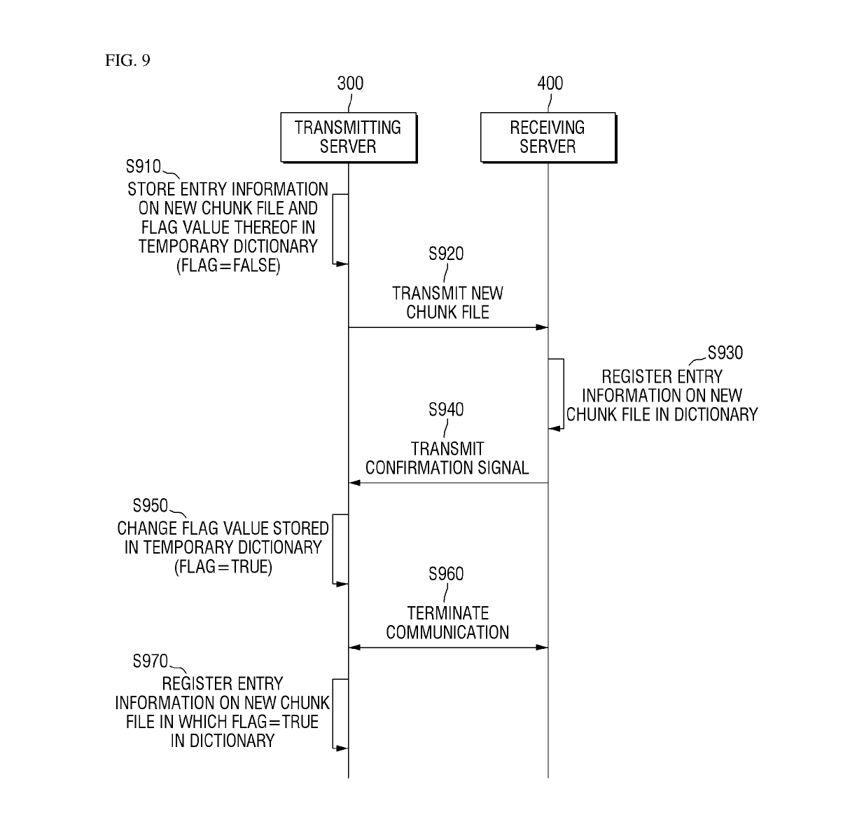

FIG. 9 is a flowchart illustrating a dictionary synchronization method according to a fourth embodiment.

The transmitting server 300 may register entry information on the new chunk file and a flag value thereof in a temporary dictionary (S910). In this case, an initial flag value may be stored as “flag=false”. The temporary dictionary such as a buffer or a memory may temporarily store entry information on the new chunk file and a flag value thereof.

When the transmitting server 300 transmits the new chunk file to the receiving server 400 (S920), the receiving server 400 may register entry information on the new chunk file in a dictionary (S930). Subsequently, the receiving server 400 transmits, to the transmitting server 300, a confirmation signal indicating that the entry information on the new chunk file has been normally registered.

The transmitting server 300 which has received the confirmation signal may change the flag value of the new chunk file stored in the temporary dictionary to “flag=true” (S950).

If a communication has terminated in a state where the flag value of the new chunk file stored in the temporary dictionary is “flag=true” (S960), the transmitting server 300 may register entry information on the new chunk file in which “flag=true” in a dictionary (S970).

That is, the entry information on the new chunk file may be temporarily stored in the temporary dictionary, and the entry information on the new chunk file having a flag value of “flag=true” is registered in a batch in the dictionary after termination of the communication, thereby reducing unnecessary traffic load.

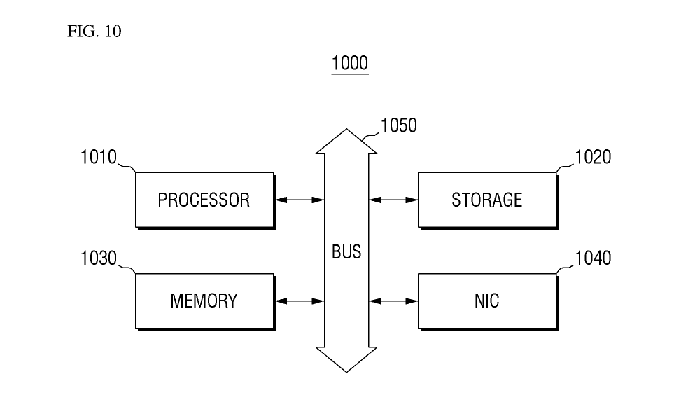

FIG. 10 is a functional block diagram illustrating a server 1000 according to one embodiment of the present inventive concept.

The server 1000 according to one embodiment of the present inventive concept may include a processor 1010, a storage 1020, a memory 1030, a network interface 1040 and a bus 1050.

FIG. 10 illustrates only the components related to embodiments of the present inventive concept. Therefore, a person skilled in the art to which the present inventive concept belongs would know that general-purpose components other than those shown in FIG. 10 could be further included.

The processor 1010 may execute a dictionary synchronization program. However, the present disclosure is not limited thereto, and other general-purpose programs can be executed.

The storage 1020 may store therein a dictionary synchronization program. Furthermore, the storage 1020 may store therein a dictionary including a new chunk file, entry information on the new chunk file and a plurality of pieces of entry information.

The processor 1010 according to one embodiment of the present inventive concept may perform data deduplication by using the dictionary stored in the storage 1020, thereby reducing traffic load generated during data transmission/reception. That is, data can be transmitted and original data can be recovered by using the dictionary stored in the storage 1020.

Meanwhile, the dictionary synchronization program stored in the storage 1020 according to the first embodiment may register entry information on a new chunk file and a flag value indicating whether the entry information is valid in a dictionary of a transmitting server; store the entry information on the new chunk file in a temporary dictionary of the transmitting server; transmit the entry information on the new chunk file to a receiving server; and delete the entry information on the new chunk file stored in the temporary dictionary upon receipt of a confirmation signal indicating that the entry information on the new chunk file has been registered in a dictionary of the receiving server.

Furthermore, the dictionary synchronization program according to the second embodiment may register entry information on a new chunk file and a flag value indicating whether the entry information is valid in a dictionary of a transmitting server; transmit the entry information on the new chunk file to a receiving server; and change the flag value upon receipt of a confirmation signal indicating that the entry information on the new chunk file has been registered in a dictionary of the receiving server.

Furthermore, the dictionary synchronization program according to the third embodiment may register entry information on a new chunk file and a flag value indicating whether the entry information is valid in a dictionary of a transmitting server; transmit the entry information on the new chunk file to a receiving server; receive a confirmation signal indicating that the entry information on the new chunk file has been registered in a dictionary of the receiving server; and change the flag value of the new chunk file for which the confirmation signal has been received upon termination of a communication session with the receiving server.

Meanwhile, the dictionary synchronization program according to the fourth embodiment may store entry information on a new chunk file and a flag value indicating whether the entry information is valid in a temporary dictionary of a transmitting server; transmit the entry information on the new chunk file to a receiving server; change the flag value stored in the temporary dictionary upon receipt of a confirmation signal indicating that the entry information on the new chunk file has been registered in a dictionary of the receiving server; and register the entry information on the new chunk file of which flag value has been changed in a dictionary of the transmitting server upon termination of a communication session with the receiving server.

The memory 1030 may load therein a dictionary synchronization program. The dictionary synchronization program loaded in the memory 1030 may be executed by the processor 1010. Furthermore, the memory 1030 may store therein a temporary dictionary for temporarily storing entry information on a new chunk file, a flag value thereof and the like.

Other computing devices may be connected to the network interface 1040. For example, a receiving server for receiving a new chunk file may be connected through the network interface 1040.

The processor 1010, the storage 1020, the memory 1030 and the like may be connected to the bus 1050 serving as a data moving path.

The methods discussed above may be created into a computer-executable program, and implemented in a general-purpose digital computer which operates the program by using a computer-readable medium. Furthermore, the structure of data used in the methods discussed above may be recorded on a computer-readable medium through various means. The computer-readable medium may include a storage medium such as a magnetic storage medium (for example, ROM, floppy disk, hard disk, etc.) and an optical read medium (for example, CD ROM, DVD, etc.).

While the present inventive concept has been particularly shown and described with reference to exemplary embodiments thereof, it will be understood by those of ordinary skill in the art that various changes in form may be made therein without departing from the essential features of the present inventive concept. It is therefore desired that the present embodiments be considered in all respects as illustrative and not restrictive, reference being made to the appended claims rather than the foregoing description to indicate the scope of the invention.

What is claimed is:

1. A dictionary synchronization method for synchronizing dictionaries between a transmitting server and a receiving server, the dictionary synchronization method comprising:
registering entry information on a new chunk file and registering a flag value indicating whether the entry information is valid in a first dictionary of the transmitting server;
storing the entry information on the new chunk file in a temporary dictionary of the transmitting server;
transmitting the entry information on the new chunk file to the receiving server; and
in response to receiving a confirmation signal indicating that the entry information on the new chunk file has been registered in a dictionary of the receiving server, deleting the entry information on the new chunk file stored in the temporary dictionary.

2. The dictionary synchronization method of claim 1, wherein the registering the flag value indicating whether the entry information is valid in the first dictionary of the transmitting server comprises registering the flag value in the first dictionary of the transmitting server such that the flag value has a value indicating that the entry information is valid.

3. The dictionary synchronization method of claim 1, further comprising maintaining the entry information on the new chunk file in the temporary dictionary, and changing the flag value such that the flag value has a value indicating that the entry information is invalid.

4. The dictionary synchronization method of claim 3, further comprising re-transmitting the entry information on the new chunk file stored in the temporary dictionary to the receiving server.

5. A dictionary synchronization method for synchronizing dictionaries between a transmitting server and a receiving server, the dictionary synchronization method comprising:
registering entry information on a new chunk file and registering a flag value indicating whether the entry information is valid in a dictionary of the transmitting server;
transmitting the entry information on the new chunk file to the receiving server; and
in response to receiving a confirmation signal indicating that the entry information on the new chunk file has been registered in a dictionary of the receiving server, changing the flag value.

6. The dictionary synchronization method of claim 5, wherein the registering the flag value in the dictionary of the transmitting server comprises registering the flag value in the dictionary of the transmitting server such that the flag value has a value indicating that the entry information is invalid.

7. The dictionary synchronization method of claim 6, wherein the changing the flag value comprises changing the flag value such that the flag value has a value indicating that the entry information is valid.

8. The dictionary synchronization method of claim 5, wherein the registering the entry information on the new chunk file and registering the flag value indicating whether the entry information is valid in the dictionary of the transmitting server comprises registering a lot number that is an identifier allocated to a group comprising a plurality of new chunk files in the dictionary of the transmitting server.

9. The dictionary synchronization method of claim 8, wherein the changing the flag value comprises, in response to receiving a confirmation signal indicating that a plurality of new chunk files having a same lot number allocated thereto have been registered in the dictionary of the receiving server, changing flag values of the plurality of new chunk files based on the lot number.

10. A dictionary synchronization method for synchronizing dictionaries between a transmitting server and a receiving server, the dictionary synchronization method comprising:
registering entry information on a new chunk file and registering a flag value indicating whether the entry information is valid in a dictionary of the transmitting server;
transmitting the entry information on the new chunk file to the receiving server;
receiving a confirmation signal indicating that the entry information on the new chunk file has been registered in a dictionary of the receiving server; and
in response to terminating a communication session with the receiving server, changing the flag value of the new chunk file for which the confirmation signal has been received.

11. The dictionary synchronization method of claim 10, wherein the registering the flag value in the dictionary of the transmitting server comprises registering the flag value in the dictionary of the transmitting server such that the flag value has a value indicating that the entry information is invalid.

12. The dictionary synchronization method of claim 11, wherein the changing the flag value comprises changing the flag value such that the flag value has a value indicating that the entry information is valid.

13. The dictionary synchronization method of claim 10, wherein the registering entry information on a new chunk file and registering a flag value indicating whether the entry information is valid in the dictionary of the transmitting server comprises registering a lot number that is an identifier allocated to a group comprising a plurality of new chunk files in the dictionary of the transmitting server.

14. The dictionary synchronization method of claim 13, wherein the changing the flag value comprises, in response to receiving a confirmation signal indicating that a plurality of new chunk files having the same lot number allocated thereto have been registered in the dictionary of the receiving server, changing flag values of the plurality of new chunk files according to the lot number.

15. A dictionary synchronization method for synchronizing dictionaries between a transmitting server and a receiving server, the dictionary synchronization method comprising:
storing entry information on a new chunk file and storing a flag value indicating whether the entry information is valid in a temporary dictionary of the transmitting server;
transmitting the entry information on the new chunk file to the receiving server;
in response to receiving a confirmation signal indicating that the entry information on the new chunk file has been registered in a dictionary of the receiving server, changing the flag value stored in the temporary dictionary; and
in response to terminating a communication session with the receiving server, registering the entry information on the new chunk file of which flag value has been changed in the dictionary of the transmitting server.

16. The dictionary synchronization method of claim 15, wherein the storing entry information on the new chunk file and storing the flag value indicating whether the entry information is valid in a temporary dictionary of the transmitting server comprises storing the flag value in the temporary dictionary of the transmitting server such that the flag value has a value indicating that the entry information is invalid.

17. The dictionary synchronization method of claim 16, wherein the changing the flag value stored in the temporary dictionary comprises changing the flag value such that the flag value has a value indicating that the entry information is valid.

18. A server comprising:
at least one processor;
a storage in which a computer program for dictionary synchronization, executable by the at least one processor, is stored; and
a memory in which the computer program for dictionary synchronization is loaded, the computer program for dictionary synchronization causing the at least one processor to execute a process comprising:
registering entry information on a new chunk file and registering a flag value indicating whether the entry information is valid in a dictionary of a transmitting server;
storing the entry information on the new chunk file in a temporary dictionary of the transmitting server;
transmitting the entry information on the new chunk file to a receiving server; and
in response to receiving a confirmation signal indicating that the entry information on the new chunk file has been registered in a dictionary of the receiving server, deleting the entry information on the new chunk file stored in the temporary dictionary.

19. A server comprising:
at least one processor;
a storage in which a computer program for dictionary synchronization, executable by the at least one processor, is stored; and
a memory in which the computer program for dictionary synchronization is loaded, the computer program for dictionary synchronization causing the at least one processor to execute a process comprising:
registering entry information on a new chunk file and a flag value indicating whether the entry information is valid in a dictionary of a transmitting server;
transmitting the entry information on the new chunk file to a receiving server; and
in response to upon receiving a confirmation signal indicating that the entry information on the new chunk file has been registered in a dictionary of the receiving server, changing the flag value.

20. A server comprising:
at least one processor;
a storage in which a computer program for dictionary synchronization, executable by the at least one processor, is stored; and
a memory in which the computer program for dictionary synchronization is loaded, the computer program for dictionary synchronization causing the at least one processor to execute a process comprising:
registering entry information on a new chunk file and a flag value indicating whether the entry information is valid in a dictionary of a transmitting server;
transmitting the entry information on the new chunk file to a receiving server;
receiving a confirmation signal indicating that the entry information on the new chunk file has been registered in a dictionary of the receiving server; and
in response to terminating a communication session with the receiving server, changing the flag value of the new chunk file for which the confirmation signal has been received.

21. A server comprising:
at least one processor;
a storage in which a computer program for dictionary synchronization, executable by the at least one processor, is stored; and
a memory in which the computer program for dictionary synchronization is loaded, the computer program for dictionary synchronization causing the at least one processor to execute a process comprising:
storing entry information on a new chunk file and storing a flag value indicating whether the entry information is valid in a temporary dictionary of a transmitting server;
transmitting the entry information on the new chunk file to a receiving server;
in response to receiving a confirmation signal indicating that the entry information on the new chunk file has been registered in a dictionary of the receiving server, changing the flag value stored in the temporary dictionary; and
in response to terminating a communication session with the receiving server, registering the entry information on the new chunk file of which flag value has been changed in a dictionary of the transmitting server.
